(19) United States
(12) Patent Application Publication
(10) Pub. No.: US 2010/0307944 A1
(43) Pub. Date: Dec. 9, 2010

(54) SYSTEM AND METHOD FOR DISTRIBUTION OF PERSONALIZED BOOKS

(76) Inventor: Christopher A. Johnson, Eden Prairie, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/773,750

(22) Filed: May 4, 2010

Related U.S. Application Data
(60) Provisional application No. 61/175,279, filed on May 4, 2009.

(51) Int. Cl. A45F 5/12; B65D 85/00; B42D 1/00; B42D 3/00; B42D 15/00

(52) U.S. Cl. 206/424; 206/459.5; 281/21.1; 281/29; 283/70; 283/81

(57) ABSTRACT

A system and method for packaging, shipping, and distributing personalized books is provided. In one embodiment, the system comprises a container having a plurality of wall panels attached to one another to define a central space within the container. One or more of the wall panels of the container comprise an access portion that may be readily displaced to provide access to the central space. A plurality of personalized books, each having an associated identification structure, are positioned in the container such that upon displacement of the access portion the identification structure is at least partially visible to a user.

### FIELD OF THE INVENTION

The present disclosure relates to systems and methods for distributing goods. More particularly, the present disclosure relates to systems and methods for packaging, shipping, and distributing personalized books.

### BACKGROUND

Books created to commemorate an event and/or experience, such as for example yearbooks or memory books, may be personalized. For example, personalization of a yearbook may include embossing the purchaser's name on a cover of the yearbook, including yearbook content which has been selected by the purchaser, such as images and text, or other customization elements used in memory books, scrapbooks, yearbooks, etc.

The personalized books are generally shipped to a single destination, such as a school, for further distribution. Typically, the personalized books are shipped to their destination in containers containing several books. Because of the unique attributes of each book, the books may not be randomly distributed to the group of purchasers as was common for non-personalized yearbooks. Rather, the identity of the purchaser of each book must be ascertained for the each personalized book to be distributed.

Current methods for distributing personalized books have several disadvantages. For example, identifying the purchaser of each personalized book can be difficult and time consuming. Often the personalized books may not be immediately identifiable, such as when the cover is not customized. Further, even if the cover is customized, personalization may only be viewed from one side of the book and this portion may not be viewable as packaged in the shipping container. Identification of the purchaser associated with each personalized book thus typically requires manual removal of all of the books from their shipping containers. Moreover, once removed from the shipping containers, due to space constraints, the books are often stacked on tables. Again, because the unique attributes of each book are often provided on only one side of the personalized book (if viewable on the outside of the book), the unique attributes of only a small fraction of the personalized books in a stack are visible.

### BRIEF SUMMARY OF THE INVENTION

Systems and methods for distributing goods are provided. More particularly, systems and methods for packaging, shipping, and distributing personalized books are provided.

In one embodiment, a system for shipping and distributing personalized books is provided. The system comprises a container having a plurality of wall panels attached to one another to define a central space within the container. One or more of the wall panels of the container comprise an access portion that may be readily displaced to provide access to the central space. A plurality of personalized books, each having an associated identification structure, are positioned in the container such that upon displacement of the access portion the identification structure is at least partially visible to a user.

In a further embodiment, a method for shipping and distributing personalized books is provided. The method comprises providing a container comprising a plurality of wall panels attached to one another to define a central space within the container. One or more of the panels comprise an access portion configured such that it may be readily displaced to provide access to the central space. The method further comprises providing a plurality of personalized books each having an associated identification structure. The method also comprises positioning the plurality of personalized books within the central space such that upon displacement of the access portion the identification structure is at least partially visible to a user.

In yet another embodiment, a system for shipping and distributing personalized books is provided. The system comprises a container having a plurality of wall panels attached to one another to define a central space within the container. One or more of the wall panels comprise an access portion that may be readily displaced to provide access to the central space. The container comprises a release strip positioned on a perimeter of the access portion such that upon removal of the release strip the access portion may be displaced to provide access to the central space. The system further comprises a plurality of personalized books each having an identification label wrapped therearound. The system also comprises the plurality of personalized books being positioned in the central space such that upon displacement of the access portion the identification label is at least partially visible to a user.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 illustrates a perspective view of a shipping container according to some embodiments.

FIG. 2 illustrates another perspective view of the shipping container of FIG. 1.

FIG. 3 illustrates yet another perspective view of the shipping container of FIG. 1.

FIG. 4 illustrates a perspective view of a shipping container according to some embodiments.

FIG. 5 illustrates another perspective view of the shipping container of FIG. 4.

FIG. 6 illustrates a perspective view of a container having a plurality of personalized books arranged therein in accordance with some embodiments.

FIG. 7 illustrates a perspective view of an exemplary pair of personalized books.

FIG. 8 illustrates a perspective view of a personalized book having an identification label associated therewith according to some embodiments.

FIG. 9 illustrates a perspective view of a personalized book having an identification label associated therewith according to some embodiments.

FIG. 10 illustrates a perspective view of a personalized book having an identification label associated therewith according to some embodiments.

FIG. 11 illustrates a system for labeling customized products, in accordance with some embodiments.

FIG. 12 illustrates a method for labeling customized products, in accordance with some embodiments.

FIG. 13 illustrates a manual process for labeling products in accordance with some embodiments.

FIG. 14 illustrates an example manual system, in accordance with some embodiments.

FIG. 15 illustrates a perspective view of a labeling machine and printer, in accordance with some embodiments.

FIG. 16 illustrates a top plan view of the labeling machine and printer of FIG. 15.

### DETAILED DESCRIPTION

### A. Overview

The present disclosure relates to a system and method for packaging, shipping, and distributing personalized books. In one embodiment, the system and method may include a container for receiving and containing a plurality of personalized books. The container may be suitable for shipping the books. The container may have at least one portion that is easily displaced to provide access to the personalized books. The system and method may further include removable identification labels for placement on each of the personalized books, the removable identification labels having purchaser identifying information printed thereon.

The system and method of the present disclosure may be used by groups purchasing a plurality of personalized books, such as schools, to readily access the books within a shipping container and to distribute the books from the shipping container. In some embodiments, access of the books within the shipping container may be done without the use of tools. The system and method of the present disclosure may be used by groups purchasing a plurality of personalized books to readily identify the purchaser of each personalized book without having to remove the books from the shipping container. It is to be appreciated that aspects of the systems and methods provided herein may be used for labeling non-personalized or generic books in a personalized manner. Thus, for example, a non-personalized or generic book (common to a school, for example) may be labeled with an individual student's name such that the book is easily distributed to the appropriate student. In this manner, distribution of non-personalized books may be facilitated along with distribution of personalized books.

While the system and method of the present disclosure may be used by any group purchasing a plurality of personalized books, the system and method of the present disclosure has specific application to personalized books distributed in schools or to organized groups (such as a dance team). Such books may be, for example yearbooks or memory books.

### B. Shipping Container

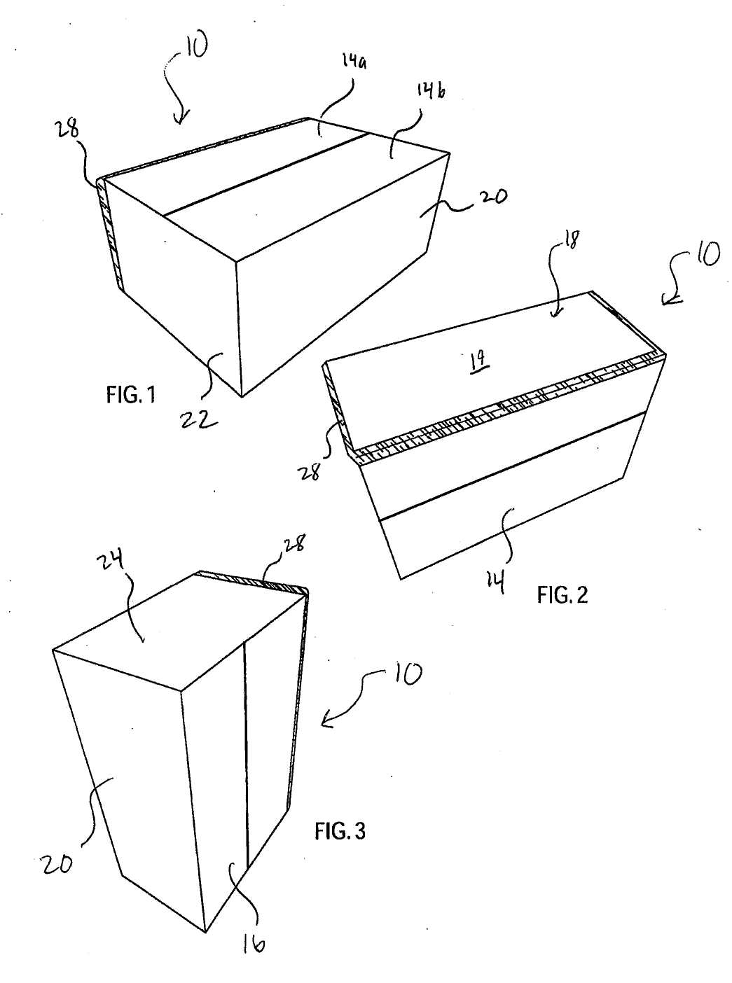

FIGS. 1-3 illustrate perspective side views of a shipping container 10 according to some embodiments. The container 10 may be adapted for protection of the container's contents during shipping and storage and for easy conversion of the container 10 from a shipping and storage configuration to a display configuration. To facilitate the transformation between configurations for shipping and display, the container 10 may be provided with one or more access portions that may be readily displaced to provide access to the contents of the container 10.

In some embodiments, container 10 may include six wall panels, top panel 14, bottom panel 16, front panel 18, back panel 20, and side panels 22 and 24. Top panel 14 may be configured as a non-unitary panel such that top panel 14 may be formed from a plurality of flaps that extend from adjacent panels and which may be attached to one another to define top panel 14. For example, top panel 14 may be formed from first and second flaps 14a and 14b which extend from front panel 18 and back panel 20, respectively. First and second flaps 14a and 14b may be held closed by adhesive tape or other suitable sealing means. In contrast to top panel 14, and in some embodiments, panels 16, 18, 20, 22, and 24 may be configured as unitary panels. In alternative embodiments, any of the wall panels of container 10 may be configured as non-unitary panels (i.e., formed from a plurality of flaps that extend from adjacent panels, any of which may overlap or not overlap), unitary panels, or any combination thereof. Further, in some embodiments bottom panel 16 may be configured substantially similarly to top panel 14.

With specific reference to FIG. 2, in one embodiment, one or more panels of container 10, and/or portions of container 10, may comprise an access portion 19 configured to provide access to a central space within container 10 upon removal of a release strip 28. Generally, access portions 19 facilitate quick access to the contents of the container 10, and may minimize the risk of damage to the contents which may result from opening container 10 with sharp tools. As illustrated, substantially all of front panel 18 may comprise an access portion 19 that provides access to the contents of container 10 upon removal of release strip 28. In alternative embodiments, any portion of front panel 18 may comprise an access portion 19, such as for example, a cut-out of front panel 18. The cut-out may have any shape, such as for example, circular, polygonal, ellipsoidal, and the like. In yet further embodiments, other panels, such as the top panel, bottom panel, back panel, or a side panel, may be used as the access panel 19.

In some embodiments, a release strip 28 may be provided on at least a portion of the perimeter of access portion 19. Generally, release strip 28 may comprise any material or structure configured to be readily removed from container 10 or fractured such that the contents of the container 10 can be readily accessed via the access portion 19. In some embodiments, the release strip 28 may be configured such that it may be removed from the container 10 without the use of tools, such as by grasping and pulling. For example, release strip 28 may comprise a tear-away strip that has been formed into the container 10, such as for example, perforated strips or zipper rules. In another embodiment, release strip 28 may comprise one or more pieces of adhesive tape. In such an embodiment, the tape may be positioned on the container 10 such that tape is folded over the perimeter of the access portion 19 such that it adheres to the access portion 19 and one or more of the panels 14, 16, 22, and 24. In this manner, with respect to embodiments in which the release strip 28 comprises adhesive tape, a cutting instrument used to open the container 10 may be run along and fracture the tape substantially parallel to the front panel 18/access portion 19, thereby reducing the risk that the contents of the container 10 are damaged during opening.

In one embodiment, release strip 28 may comprise a tear-away strip that is provided on three sides of access portion 19 and wherein access portion 19 is hinged along a fourth side. In accordance with such embodiment, upon removal or the tear away strip, the access portion 19 may be folded along the fourth side to provide access to the interior of the container. In a further embodiment, release strip 28 may comprise one or more pieces of readily removable or fracturable adhesive tape arranged on three sides of the access portion 19 and wherein access portion 19 is hinged along a fourth side. In accordance with such an embodiment, upon removal or fracture of the removable adhesive tape, the access portion may be folded along the fourth side to provide access to the interior of the chamber. Alternatively, release strip 28 (regardless of exact configuration) may be provided on each side of the access portion 19 such that access portion 19 may be entirely removed from the container 10. In yet another embodiment, release strip 28 may include a tear-away strip formed into the container 10, as well as one or more strips of adhesive tape arranged on the perimeter of the access portion 19 and provided over the tear-away strip. In such an embodiment, pulling or grasping of the tear-away strip may cause the adhesive tape to fracture, thereby allowing access to the contents of the container 10.

In an alternative embodiment, front panel 18 may comprise a non-unitary structure, such as for example, a first flap extending from the top panel 14 and a second flap extending from the bottom panel 16. The first flap and the second flap may attached to one another by means of a release strip 28. In this embodiment, upon removal of release strip 28, both of the first and second flaps, which form together, form an access portion, may be hinged about their sides adjacent the top panel 14 and bottom panel 16, respectively, to facilitate access to the contents of the container 10.

While the foregoing has described access portion 19 on front panel 18 or portions thereof, it is to be understood that any of the wall panels of the container 10, or portions thereof, may include an access portion 19. For example, in one embodiment, at least two panels of the container 10, or a portion of at least two panels of container 10, may form an access portion 19. For example, release strip 28 may define a perimeter of an access portion 19 formed on portions of at least two panels, such as for example, portions of front panel 18 and top panel 14, that are contiguous. In some embodiments, more than one access portion may be provided.

In some embodiments, the bond between access portion 19 and the container 10 via release strip 28, may be strong enough to prevent unintentional removal of the access portion 19 during shipping and handling but will come off readily without any significant damage to the container or its contents when intentionally removed.

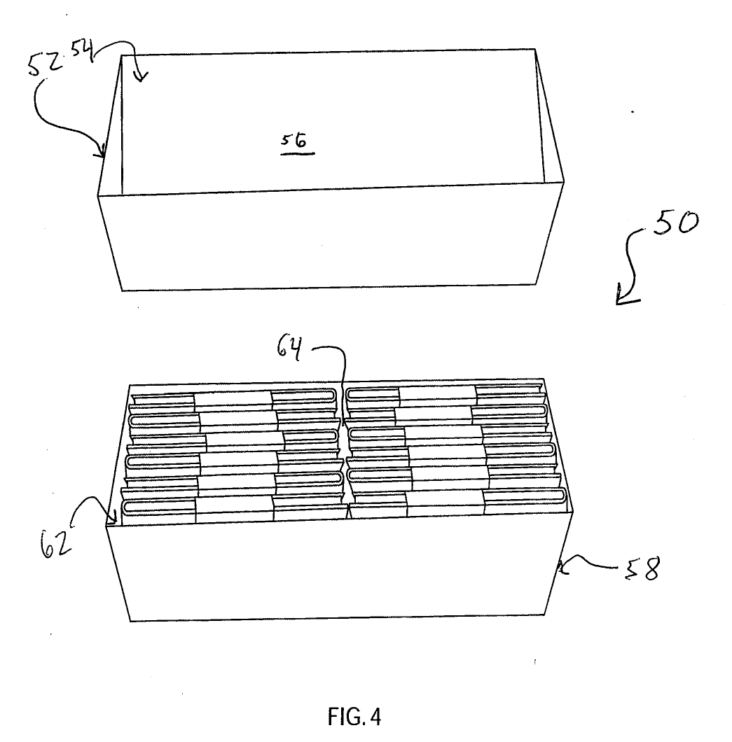

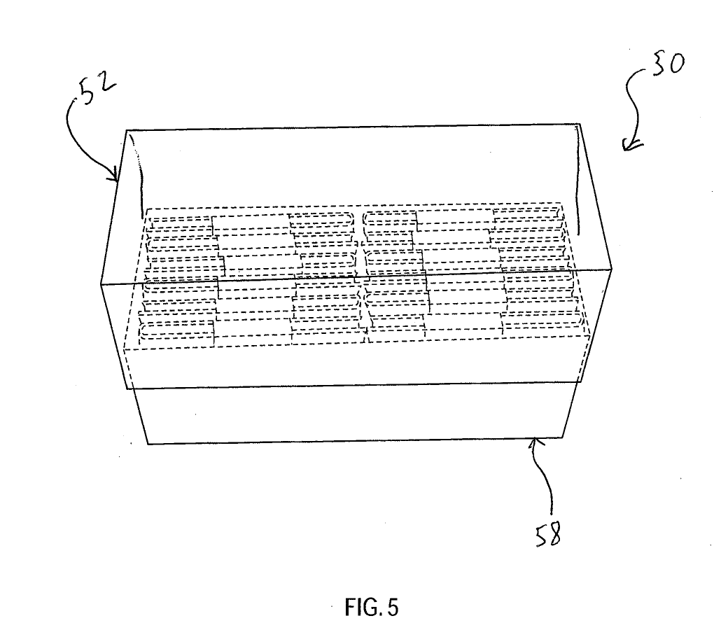

FIGS. 4-5 illustrate perspective views of a shipping container 50 according to an alternative embodiment. Container 50 may include a first container portion 52 formed as a five-panel structure having an open end 54 that defines an opening to a first central space 56, and a second container portion 58 formed as a five-panel structure having an open end 62 that defines an opening to a second central space 64. As shown, first container portion 52 and second container portion 56 may be of the same general configuration, with the first container portion 52 being of slightly greater dimension than the second container portion 58. In this manner, the first container portion 52 may be slid, via its open end 54 on top of the second container portion 58 such that second container portion 58 is received in first central space 56 and maintained therein through friction-fitting. Additionally, or alternatively, an adhesive may be used to maintain the positions of first and second container portions 52 and 58. The resulting container 50 may securely accommodate a plurality of articles, such as personalized books, in the second central space 64.

In certain embodiments, one or more panels of the containers of the present disclosure (10 and/or 50) may have graphics, text, or other identifying characteristics provided thereon. For example, the identifying characteristics may include information about the contents of the container, instructions for packaging, shipping, storing, and/or opening, shipping information, and/or advertising information. In a particular embodiment, one or more panels of the containers may be provided with indicia sufficient to indicate whether the container includes personalized books, such as text, graphics, color, or other identifying characteristic. Such indicia may be particularly beneficial in embodiments in which several containers may sent to a single destination, only some of which have personalized books. In this manner, the containers carrying the personalized books may be readily distinguished from those carrying only non-personalized books. Alternatively, any suitable identifying characteristic may be provided on the containers by adhering a material, such as a sticker, having a color, text, graphics, or other provided thereon to one or more panels of the containers to convey desired information.

In some embodiments, the containers may be formed from corrugated cardboard, other cardboards, paperboard, fiberboard, plastic sheet, plastic corrugated sheet, other suitable materials, or combinations thereof. In embodiments in which the containers are formed of corrugated material, any or all of the panels that make up the containers may be formed as two-ply panels that include both large and small flutes within the corrugation. In this manner, increased protection to the contents of the containers is provided, while maintaining a thin material profile.

In various embodiments, shipping container 10 may be produced by using traditional or non-traditional methods of producing paperboard boxes, and may be produced in traditional or non-traditional sizes. In further embodiments, one or more portions of the container 10 may comprise a transparent material such that visual access may be provided to the central space of the container 10 without requiring physical access to the central space of the container 10.

### C. Personalized Books

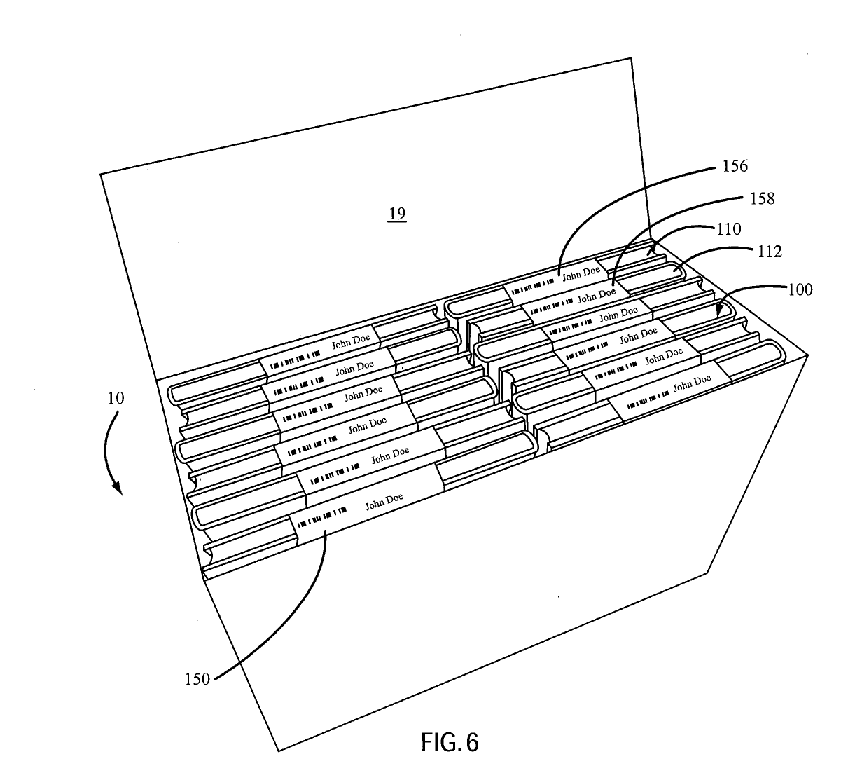

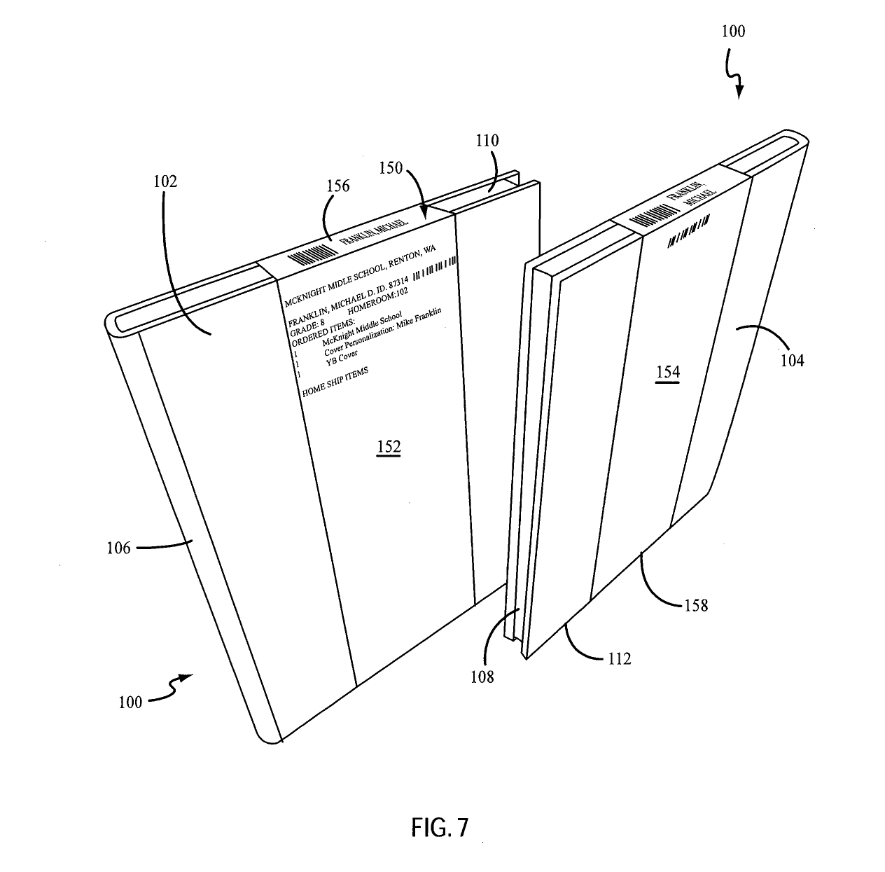

The containers of the present disclosure may be sized and shaped to accommodate a plurality of personalized goods, such as for example, personalized yearbooks, memory books, and the like. FIG. 6 illustrates a perspective view of the container 10 having a plurality of personalized books 100 contained therein in accordance with some embodiments. FIG. 7 illustrates a perspective view of an example pair of personalized books 100. Personalized books, generally, may contain text, images, and/or content that is unique to the purchaser. For example, a personalized book 100 may have the name of the purchaser of the book embossed on a front cover of the book. Additionally, for example, a personalized book may have one or more images/icons on the front cover of the book that have been selected by the purchaser. In other embodiments, a personalized book may have pages added to the book specific to the purchaser such that the personalization elements are not viewable along an exterior portion of the book. Distribution of the personalized books 100 requires identification of the purchaser of each personalized book.

Again referring to FIG. 7, personalized books 100 may define a front cover 102, a rear cover 104, a bound edge 106, an open edge 108 extending substantially parallel to bound edge 106, and a pair of open edges 110, 112 extending substantially perpendicular to bound edge 106. The materials, sizes, and types of pages of personalized books 100 may vary widely, as will be appreciated by those skilled in the art.

In some embodiments, an identification structure 150, such as for example a label, tag, or the like, may be associated with each personalized book 100. Generally, an identification structure may contain information about or relating to the purchaser of the personalized book with which it is associated. In some embodiments, the identification structure 150 may be attached on or to, or generally associated with, the personalized book 100. As will be discussed in further detail, an identification structure may be positioned such that the purchaser of the personalized book 100 may be readily identified when the personalized book 100 is packaged in a container 10 and/or stacked on a table.

In one embodiment, identification structure 150 may comprise an identification label 150 provided on an external portion of the personalized book 100. For example, as shown in FIG. 7, an identification label 150 may be arranged about a portion of the external surface of personalized book 100 on the long dimension thereof, substantially parallel to bound edge 106, such that identification label 150 encircles front cover 102 and rear cover 104, defining a first portion 152 adjacent front cover 102, a second portion 154 adjacent rear cover 104, a third portion 156 adjacent open edge 110, and a fourth portion 158 adjacent open edge 112.

Referring still to FIG. 7, identification label 150 may comprise a continuous label sized and shaped such that it may be slid over the external surface of personalized book 100 and maintained on personalized book 100 through friction fitting. Alternatively, identification label 150 may be further maintained on personalized book 100 by a suitable adhesive. In one embodiment, identification label 150 may have a width which is substantially shorter than the width of front cover 102 and rear cover 104. Alternatively, identification label 150 may have any width similar to that of front cover 102 and rear cover 104, such as for example, substantially the same width as front cover 102 and rear cover 104.

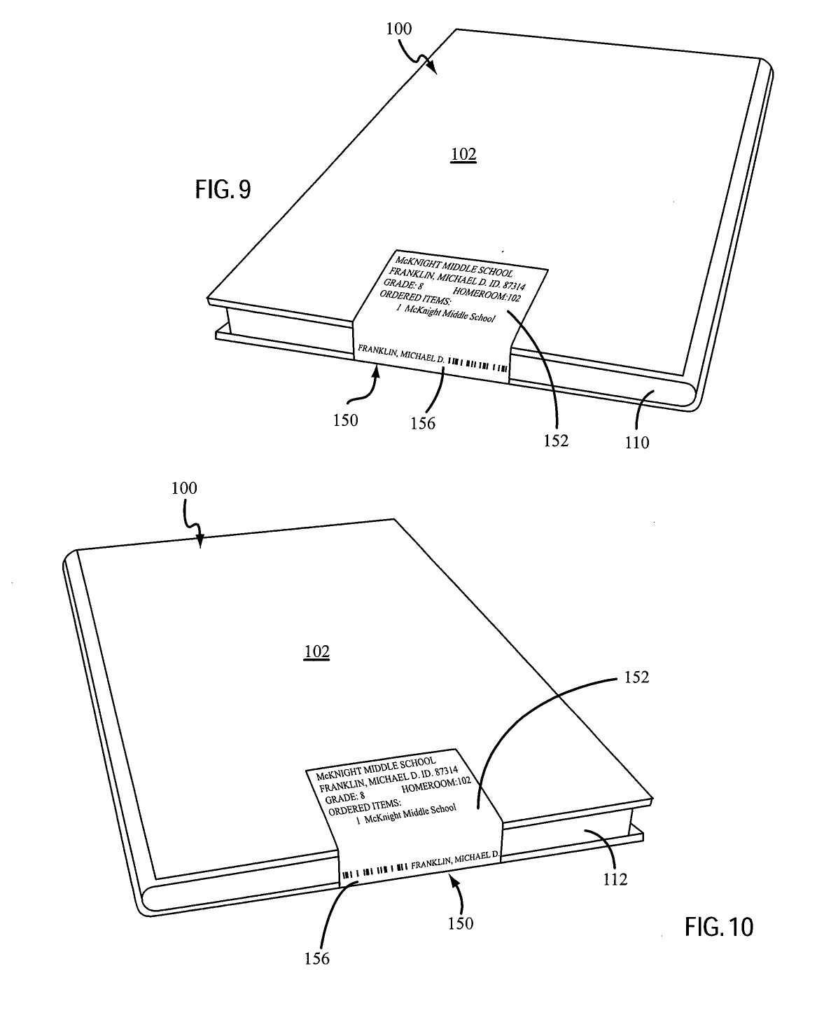

In an alternative embodiment, identification label 150 may extend about only a portion of front cover 102 and/or rear cover 104. For example, as illustrated in FIGS. 9 and 10, identification label 150 may be provided at either open end 110 or open end 112 (i.e., either the head or the foot of the book) and extend along only a portion of front cover 102 and/or rear cover 104. In a particular embodiment, the identification label 150 may be approximately 3 inches in width and 6 inches in length, and may be positioned on either open end 110 or open end 112 such that the identification label 150 extends along front cover 102 and the rear cover 104 a substantially similar distance. Similar to previous embodiments, in the embodiment of FIGS. 9 and 10, the identification label 150 may include a first portion 152 adjacent front cover 102, a second portion 154 adjacent rear cover 104, and a third portion 156 adjacent open edge 110 or open edge 112. In alternative embodiments, a partial identification label 150 may extend along any portions of the book including to span bound edge 106 or open edge 108.

The identification label 150 of FIGS. 9 and 10 may be maintained on personalized book 100 by any suitable attachment method including, for example, a low tack removable adhesive formulated to have an adhesion strength sufficient to hold the label 150 in position, yet be readily removable, by gripping and pulling, without damaging front and/or rear covers 102,104. The adhesive may be selected such that no adhesive residue remains on the book after removal of the identification label 150.

In some embodiments, any or all of first portion 152, second portion, 154, third portion 156, and fourth portion 158 of identification label 150 may have identifying information printed thereon. Generally, identifying information may include any information relating to the purchaser of the personalized book 100. For example, identifying information may include the name of the purchaser, an identification number assigned to the purchaser, a scannable bar code assigned to the purchaser, and/or a list of items paid for by the purchaser. As a further example, if personalized book 100 is a school yearbook/memory book, identifying information may include the name/location of the school, the grade of the purchaser, and/or the homeroom location of the purchaser. Identification information may include text, graphics, icons, color, etc.

In alternative embodiments, in addition to identification information, identification label 150 may have supplementary information printed thereon. Supplementary information may include, for example, any or all of advertisements, promotional messages, thank you messages, and the like. For example, the identification information may include a coupon to a retailer.

In further alternatives, identification labels 150 may be provided in colors and/or include symbols identifying an individual purchaser or an identified segment of purchasers. For example, if personalized book 100 is a yearbook/memory book, identification labels 150 may be provided in colors and/or include symbols that identify, for example, the grade of the purchaser, the homeroom of the purchaser, or an activity group the purchaser is a member of. For example, the grade of the purchaser may be indicated by color of the identification label 150—such that a first color is used for 9^{th} grade, a second color is used for 10^{th} grade, a third color is used for 11^{th} grade, and a fourth color is used for 12^{th} grade. Further information then may be printed on the colored identification label 150.

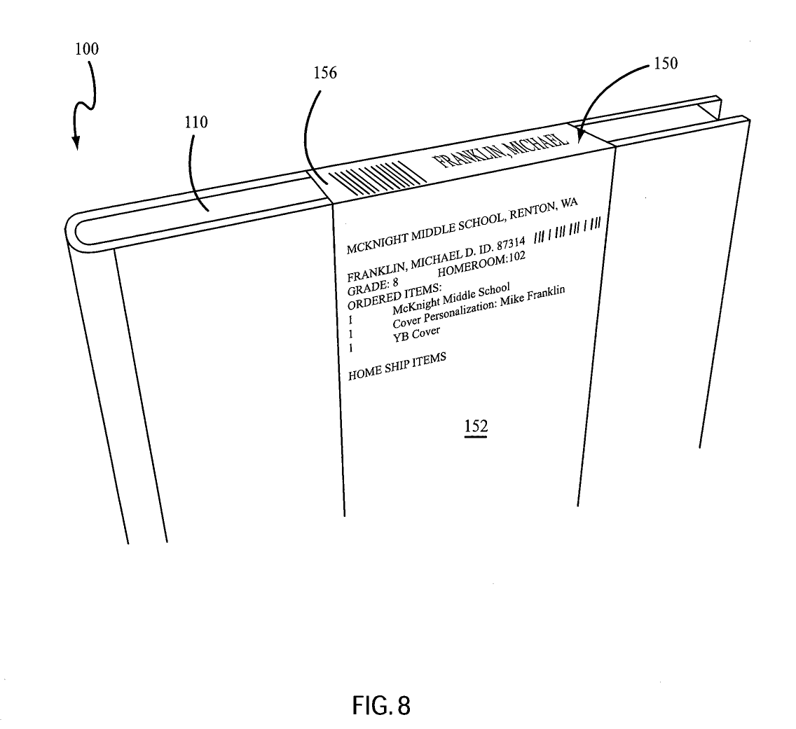

Referring again to FIG. 8, a perspective view of a personalized book 100 having an identification label 150 of the type described with respect to FIG. 7 provided thereon. In some embodiments, third and fourth portions 156, 158 of the identification label 150 may have at least the name of the purchaser of the personalized book printed thereon. In further embodiments, third and fourth portions 156, 158 may also include at least an identification number assigned to the purchaser and a scannable bar code assigned to the purchaser. As will be discussed in further detail below, both of the third and fourth portions 156, 158 may include identification information provided thereon to facilitate cross-stacking of personalized books 100 in a container.

In some embodiments, either or both of the first and second portions 152, 154 of the identification label 150 may include identifying information and/or supplementary information. For example, in one embodiment, either or both of first and second portions 152, 154 may include identifying and/or supplementary information on a section of the portions 152,154 that are adjacent open edge 110 and/or on a section of the portions 152, 154 that are adjacent open edge 112. Alternatively, identifying information and/or supplementary information may be provided anywhere on either or both of first and second portions 152, 154.

While the foregoing description is provided with respect to the identification label of FIG. 7, it is to be appreciated that substantially similar types of information may be provided on the analogous portions of the identification label of FIGS. 9-10. Further, while specific orientation of the identification label 150 to the book is discussed, it is to be appreciated that the identification label 150 may be otherwise oriented on the book.

When the personalized books 100 are distributed to purchasers, identification labels 150 can be removed by, for example, sliding the label off of the book, manual tearing/pulling of the label, and/or application of a cutting tool to the label.

### D. Packaging and Distribution

Referring again to FIG. 6, in some embodiments, a plurality of personalized books 100 having identification labels 150 associated therewith as previously described may be packaged in container 10. In some embodiments, personalized books 100 may be arranged in container 10 such that either open edge 110 or open edge 112 of personalized book 100, and thus either third portion 156 or fourth portion 158 of identification labels 150, are positioned adjacent access portion 19. For example, as shown in FIG. 6, two columns of personalized books 100 having six books per column may be arranged in container 10 in a “cross-stack” fashion such that adjacent books within a column alternate between having open edge 110 and open edge 112 adjacent access portion 19. Cross-stacking of personalized books 100 within a column may prevent non-uniformity in column height which may occur if, for example, bound edge 106 and open edge 108 having unequal thicknesses. In alternative embodiments, container 10 may be sized to shaped to accommodate any number of columns of personalized books having any number of books per column. In further alternatives, personalized books 100 within the columns may not be cross-stacked. In still further alternatives, rather than arranged in columns, personalized books 100 may not be arranged in any suitable fashion as will be appreciated by those skilled in the art. In yet another alternative, on the basis of the purchaser name, personalized books 100 may be arranged within container 10 in alpha order. Alternatively, personalized books may be arranged in any order, such as for example, numeric order on the basis of identification numbers assigned to purchasers.

In one embodiment, to convert the container 10 into a display/distribution configuration which allows for purchasers of personalized books 100 to be readily identified, a user may remove release strip 28, thereby allowing access portion 19 to be hinged about an edge of the container defined by the intersection of front panel 18 and bottom panel 16. A user may then rotate the access portion 19 about the edge such that an opening through which a user may view and grasp the contents of the container 10 is exposed, as shown in FIG. 6. As also shown, third and fourth portions 156, 158 of identification labels 150 having identifying information printed thereon may be viewed through the access opening.

While the foregoing description of a packaging and distribution method is provided with respect to the container 10, it is to be appreciated that a substantially similar method of packaging and distribution could be carried out with the container 50 of FIGS. 3-4. For example, a plurality of personalized books 100 can be arranged in second central space 64 of container 50 such that either open edge 110 or open edge 112 of personalized books 100, and thus third portion 156 or fourth portion 158 of identification labels 150 is positioned adjacent open end 62. To convert the container 50 as into a display/distribution configuration which allows for purchasers of personalized books 100 to be readily identified, a user may remove the first container portion 52, thereby allowing access to the second central space 64.

### E. Manufacturing

A system and method may further be provided for labeling packaging customized products. In some embodiments, such system and method may be integrated with a system and method that manufactures such customized products. A tracking device, such as an RFID chip, may be incorporated into the customized product during manufacture to facilitate manufacturing and packaging.

The various systems and methods for manufacturing, labeling, and packaging are discussed with respect to a customized product. It is to be appreciated that a yearbook, memory book, or like book is within the scope of such customized product. As such, book and product may be used interchangeably below. Use of the term book is not intended to be limiting.

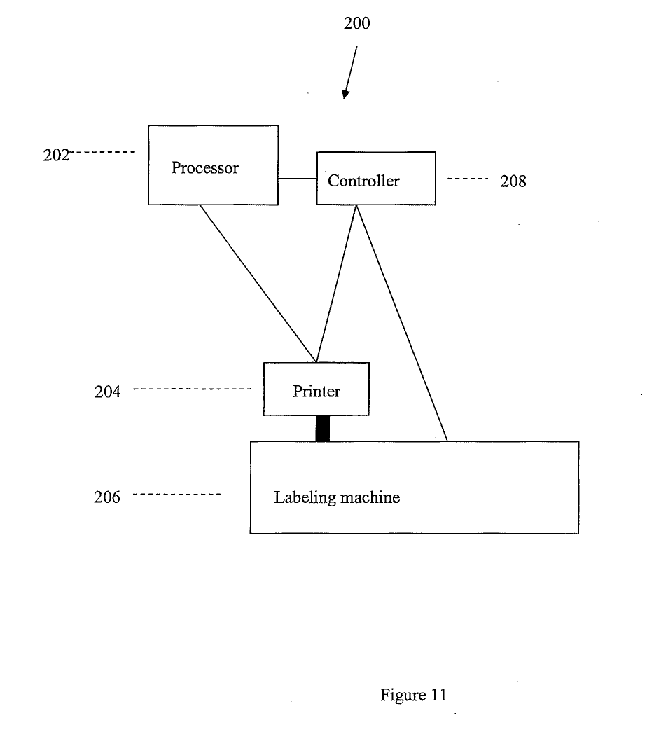

FIG. 11 illustrates one embodiment of a labeling system 200. As shown, the labeling system may include a processor 202, a printer 204, a labeling machine 206, and a controller 208. In some embodiments, a reader 210 may also be provided as part of the labeling system 200. When provided, the reader 210 may read an identifying component in the customized product. The identifying component may generally be any machine readable identification, such as an RFID chip. The reader 210 may then send information associated with the identifying component to the processor 202 In alternative embodiments, such as manual systems, a reader may not be provided and product management may be done by an operator of the system. The processor 202 may include a program for storing and managing information regarding the customized product. Such information may include information for printing on a label such as student name, grade, school, or other identification. The processor 202 may further serve to format a label for printing. The processor thus operates to receive information from the reader, correlate the information to printing information, and develop formatting instructions. The printing information and formatting instructions then may be sent to the printer. The printer 204 and labeling machine 206 may be provided as a single machine unit in some embodiments wherein the labeling machine 206 directs the product to and through the printer 204. In some embodiments, the printer 204 may be a thermal printer, an ink jet printer, or any suitable printer. The controller 208 generally directs machine reading and data transfer to the printers and controls movement of the products through the labeling machine and printer. The controller 208 further may provide for movement of the labeled product into proper sequence after labeling.

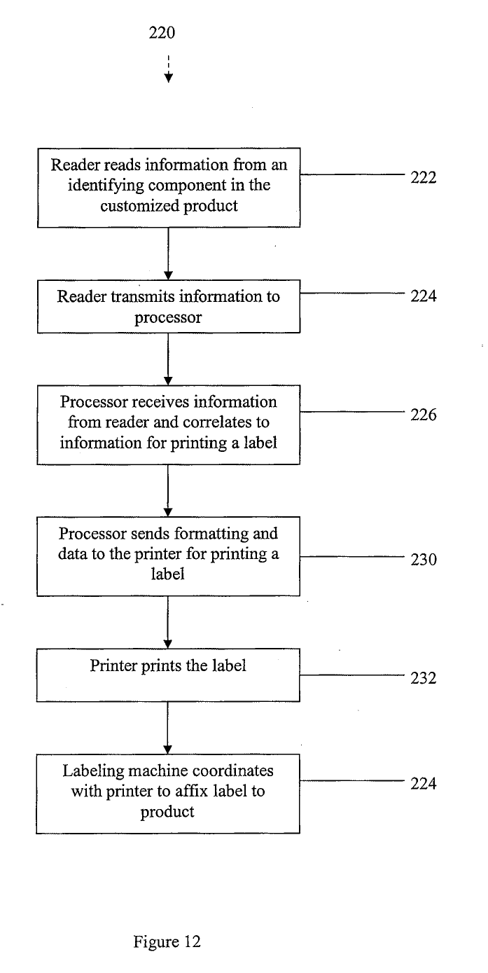

FIG. 12 illustrates a method 220 for labeling customized products. Where a reader is provided, the reader reads information from an identifying component in the customized product [block 222]. The reader then transmits that information to the processor [block 224]. The processor receives information from the reader, for example a number from the RFID chip, and correlates that information to printing information for printing a label [block 226]. In manual systems, the operator may input such a number. The number, whether provided by a reader or otherwise input, may be used to pull the information regarding the customized product. The processor then sends formatting and data to the printer for printing a label [block 230]. The printer may be provided in a position relative to the labeling machine such that the label is printed [block 232] and generally immediately affixed to the book [block 234]. In such embodiments, the labeling machine feeds the product to the label and associates the label with the product. In some embodiments, a labeling machine is provided for at least partially wrapping a label around the product. In the context of a book, the labeling machine ensures the book is shut and wraps a label over at least one edge of the book. The printer, labeling machine, and product may be coordinated such that the label is dispensed along a movement path of the product. In some embodiments, the printer dispenses an individualized label, removes the label liner or backing, and presents the adhesive side of the label to the product as it travels down a conveyor. One or more contact mechanisms, such as brushes, may be provided associated with the printer for pressing the label to the product such that the adhesive contacts opposing surfaces of the product.

The number of books that may be packaged in a carton (the term carton may be used interchangeably herein with containers for shipping and distributing products) may be calculated in advance based on the number of pages, book material, or other book specifications. The labeling process may designate certain books for placement in a specific carton. Thus, the loaded books may correlate to expected contents of the container and the container may be labeled with the names associated with the books placed therein.

### Manual System

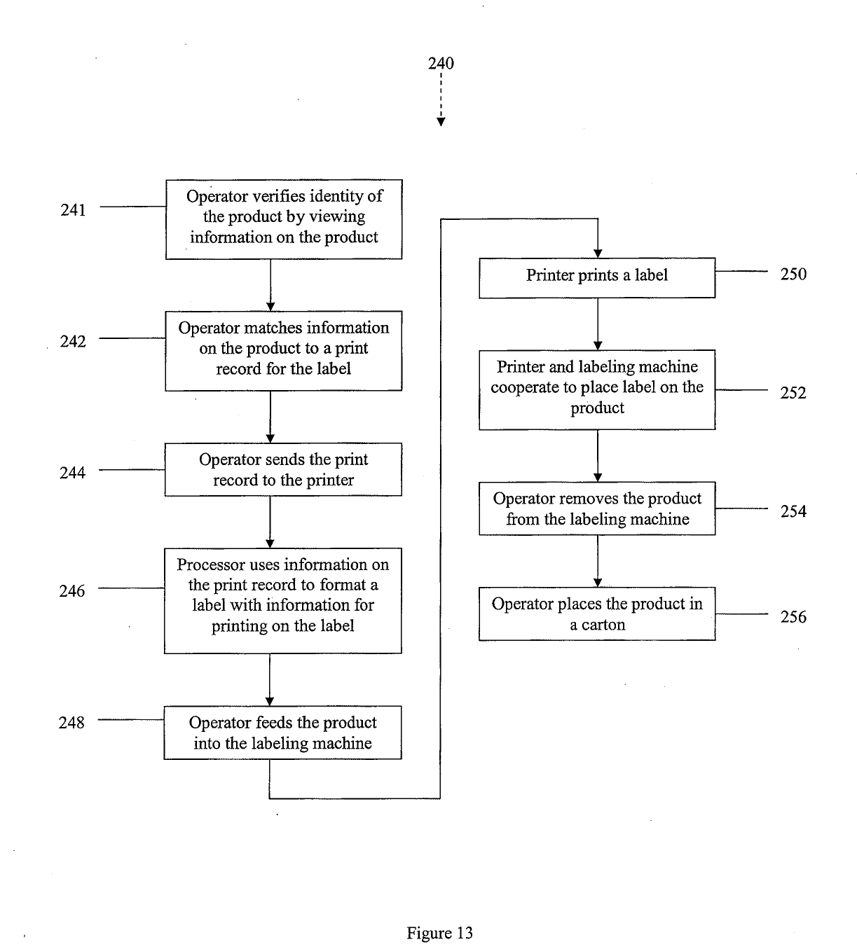

FIG. 13 illustrates a manual process 240 for labeling products. A feed operator verifies the identity of the product [block 241], for example by reading information on the product, and matches the information on the product to a print record for the label [block 242]. The feed operator then sends the print record to the printer [block 244]. A processor associated with the printer then uses information on the print record to format a label with information for printing on the label [block 246]. The operator feeds the product into the labeling machine, for example by placement on a conveyor [block 248]. The printer prints a label with associated information [block 250]. The printer and labeling machine then coordinate to place the label on the product [block 252]. A receiving operator then removes the product from the labeling machine [block 254], for example by removing the product from a conveyor, and places the product in a carton [block 256].

Accordingly, in some embodiments, and particularly in a manual feed/receiving system, the products may not contain machine readable identification. With no machine readable identification, a feed operator, who is responsible for feeding products into the system, verifies information on the product to associate it with the correct label. Typically a customized book may be printed with individual information on the front cover (such as a name stamped on the cover). As books are fed through the labeling system, the operator may track customer requested distribution grouping (for example by grade or homeroom) and sort order (alpha last name, firstname).

For packaging of books, the books may be cross stacked in a shipping container. Cross-stacking is intended to refer to placement in the book where spines of the books are placed at alternating ends of the carton in which the books are placed. Accordingly, the feed operator may rotate every other book to feed top first, then bottom first, to apply labels in an alternating fashion. In a manual feed/receiving system, the feed operator places the individual product on a conveyor, the printer dispenses an individualized label, removes the label liner or backing, and presents the adhesive side of the label to the product as it travels down a conveyor. Brushes above and below the product gently press the label so that the adhesive contacts the front and back surfaces of the product.

A receiving operator then removes each book and rotates the book to stack it in the shipping carton such that the label is exposed with the appropriate end of the carton is opened.

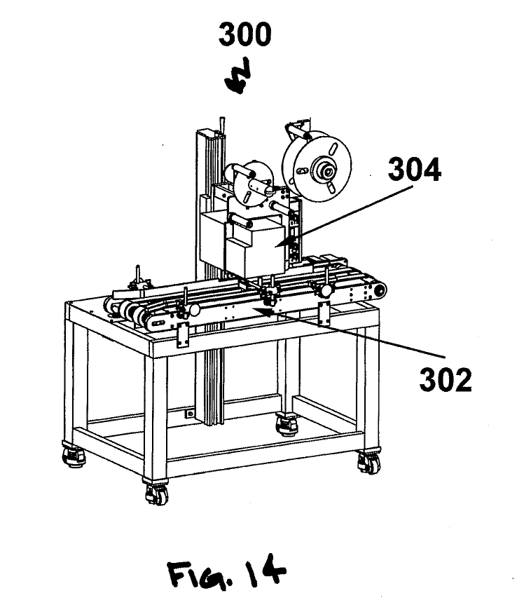

FIG. 14 illustrates an example manual system 300. As shown, the manual system 300 includes a printer 304, and a movement system 302. The manual system 300 may be referred to as the labeling machine and/or as a combined labeling machine and printer. A processor may be associated with the manual system 300 for controlling the movement system, the printer, or other components.

### Automated System

As previously discussed, the labeling system may include a processor, a reader, a printer, and a labeling machine. The reader may read an identifying component in the customized product. The identifying component may generally be any machine readable identification, such as an RFID chip. The readable identification is used to identify the product such that a corresponding label may be printed. The reader may then send information associated with the identifying component to the processor and the processor may pull corresponding information for labeling the book. The processor then sends formatting and data to the printer for printing a label for affixation to the product. The labeling machine feeds the product to the label and associates the label with the product.

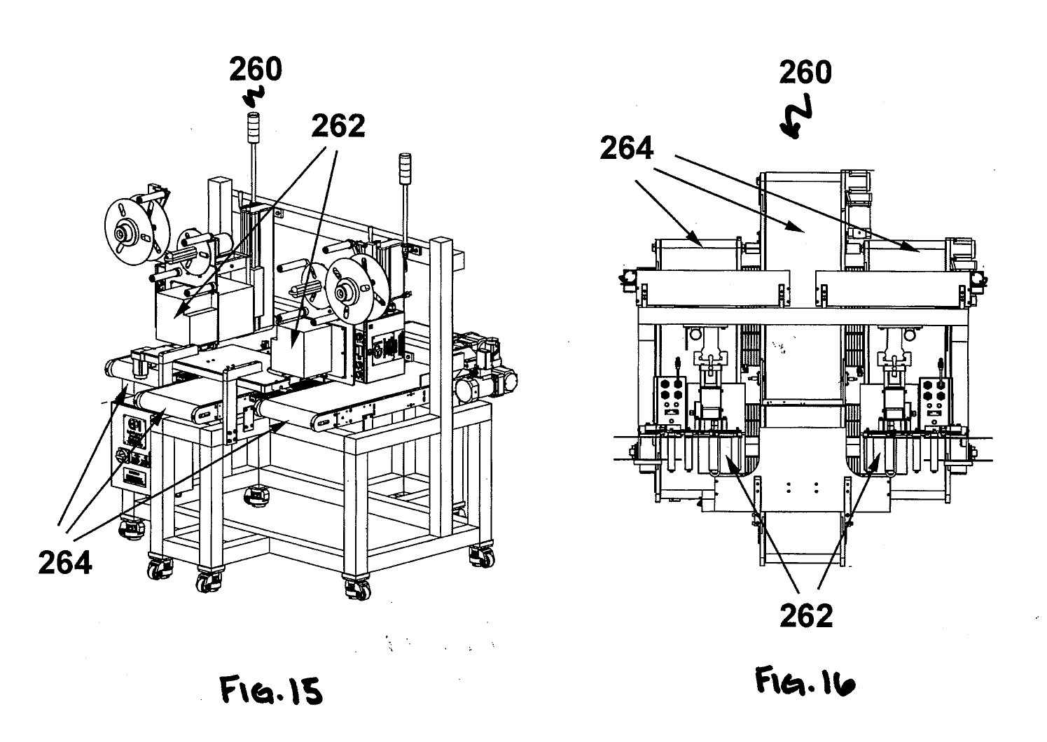

FIGS. 15 and 16 illustrate an embodiment of a labeling machine and printer 260 that may be used in the labeling system. FIG. 15 illustrates a perspective view and FIG. 16 illustrates a top plan view. The labeling machine and printer 260 have two opposing (and substantially identical) print and apply systems 262 and a book movement system 264. The book movement system 264 directs books under opposing printers of the print and apply systems 262 in an alternating fashion. This facilitates labeling opposing ends of books in an alternating fashion such that the books may be cross stacked in a carton. The printed label is dispensed in the path of the moving book (on the book movement system 264) and a contact mechanism such as brushes contact the label to facilitate adhesion of the label to opposing surfaces of the conveyor. After labeling, the products are moved in sequential order for packaging.

Although the present invention has been described with reference to preferred embodiments, persons skilled in the art will recognize that changes may be made in form and detail without departing from the spirit and scope of the invention.

We claim:

1. A system for shipping and distributing personalized books comprising:
a container having a plurality of wall panels attached to one another to define a central space within the container;
wherein one or more of the wall panels comprise an access portion that may be readily displaced to provide access to the central space; and
a plurality of personalized books each having an identification structure associated therewith;
wherein the plurality of personalized books are positioned in the central space such that upon displacement of the access portion the identification structure is at least partially visible to a user.

2. The system of claim 1, further comprising a release strip positioned on a perimeter of the access portion.

3. The system of claim 2, wherein upon removal or fracture of the release strip the access portion may be displaced to provide access to the central space.

4. The system of claim 2, wherein the release strip comprises a tear-away strip formed into the container.

5. The system of claim 2, wherein the release strip comprises a strip of adhesive tape.

6. The system of claim 2, wherein the access portion defines four sides, and wherein the release strip is provided on three sides of the access portion such that upon removal of the release strip the access portion may be hinged about the fourth side.

7. The system of claim 1, wherein the identification structure has information relating to a purchaser of the book provided thereon.

8. A system for shipping and distributing personalized books comprising:
a container having a plurality of wall panels attached to one another to define a central space within the container;
wherein one or more of the wall panels comprise an access portion that may be readily displaced to provide access to the central space; and
wherein the container comprises a release strip positioned on a perimeter of the access portion such that upon removal or fracture of the release strip the access portion may be displaced to provide access to the central space; and
a plurality of personalized books each having an identification label provided thereon;
wherein the plurality of personalized books are positioned in the central space such that upon displacement of the access portion the identification label is at least partially visible to a user.

9. The system of claim 8, wherein the release strip comprises a tear-away strip formed into the container.

10. The system of claim 8, wherein the release strip comprises a strip of adhesive tape.

11. The system of claim 8, wherein the identification labels are positioned such that they substantially surround at least a portion of the personalized books.

12. The system of claim 11, wherein the identification label is sized and shaped such that it may be maintained relative to the personalized book through friction fitting.

13. The system of claim 11, wherein the identification label has information relating to a purchaser of the personalized book provided thereon.

14. The system of claim 13, wherein the identification label has a name of the purchaser of the personalized book provided thereon.

15. The system of claim 13, wherein the identification label has a scannable bar code assigned to the purchaser of the personalized book provided thereon.

16. The system of claim 8, wherein a first of the plurality of personalized books defines a front cover, a rear cover, a bound edge, a first open edge extending substantially parallel to the bound edge, and second and third open edges extending substantially perpendicular to the bound edge, wherein the identification label comprises a first portion adjacent the second open edge, and wherein at least a name of the purchaser of the personalized book is provided on the first portion.

17. The system of claim 16, wherein a second of the plurality of personalized books defines a front cover, a rear cover, a bound edge, a first open edge extending substantially parallel to the bound edge, and second and third open edges extending substantially perpendicular to the bound edge, wherein the identification label comprises a first portion adjacent the third open edge, and wherein at least a name of the purchaser of the personalized book is provided on the first portion.

18. The system of claim 17, wherein the plurality of personalized books are positioned within the central space such that upon displacement of the access portion the respective first portions of the first and second personalized books are visible to a user.

19. The system of claim 18, wherein the personalized books are arranged within the container in a cross-stack fashion.

20. The system of claim 19, wherein the personalized books are arranged in the container in alpha order on the basis of the name of the purchaser of the personalized book.

21. A method for shipping and distributing personalized books comprising:
providing a container, the container comprising a plurality of wall panels attached to one another to define a central space within the container;
wherein one or more of the panels comprise an access portion configured such that it may be readily displaced to provide access to the central space; and
providing a plurality of personalized books each having an identification structure associated therewith; and
positioning the plurality of personalized books within the central space such that upon displacement of the access portion the identification structure is at least partially visible to a user.

22. The method of claim 21, wherein the container further comprises a release strip positioned on a perimeter of the access portion.

23. The method of claim 22, wherein upon removal or fracture of the release strip the access portion may be displaced to provide access to the central space.

24. The method of claim 21, wherein the identification structure comprises an identification label extending along at least a portion of the personalized book.

25. The method of claim 24, wherein the identification label is adhered to the personalized book with a low tack removable adhesive.

26. The method of claim 25, wherein the identification label has information relating to a purchaser of the personalized book provided thereon.

27. The method of claim 25, wherein the identification label has a name of the purchaser of the personalized book provided thereon.

28. The method of claim 25, wherein the identification label has a scannable bar code assigned to the purchaser of the personalized book provided thereon.

29. The method of claim 21, wherein each of the plurality of personalized books defines a front cover, a rear cover, a bound edge, a first open edge extending substantially parallel to the bound edge, and second and third open edges extending substantially perpendicular to the bound edge, wherein the identification label comprises a first portion adjacent the second open edge, and wherein at least a name of the purchaser of the personalized book is provided on the first portion.

30. The method of claim 29, wherein positioning the plurality of personalized books within the central space further comprises positioning the books such that upon displacement of the access portion the first portion is visible to a user.

31. The method of claim 30, wherein positioning the plurality of personalized books within the central space further comprises arranging the personalized books in a cross-stack fashion.

32. The method of claim 31, wherein positioning the plurality of personalized books within the central space further comprises arranging the personalized books in alpha order on the basis of the name of the purchaser of the personalized book.

33. A labeling system for labeling personalized products comprising:
a reader for reading information from an identifying component of the personalized products;
a processor for receiving the information from the reader, correlating the information to printing information, and developing formatting instructions;
a printer for receiving printing information and formatting instructions from the processor and using the information and instructions to print a label for each personalized product; and
a labeling machine associated with the printer for feeding the personalized product to the printer such that the label is received by and affixed to the personalized product.

34. A method for labeling a customized product comprising:
reading information from an identifying component of the customized product;
correlating the information to printing information;
printing a label with the printing information;
affixing the label to the product.
